(19) United States
(12) Patent Application Publication
(10) Pub. No.: US 2007/0126699 A1
(43) Pub. Date: Jun. 7, 2007

(54) Optical navigation device and method of operating the same

(76) Inventors: Jong-Taek Kwak, Seongnam-si (KR); Bang-Won Lee, Yongin-si (KR)

Correspondence Address: CANTOR COLBURN, LLP, 55 GRIFFIN ROAD SOUTH, BLOOMFIELD, CT, 06002, US

(21) Appl. No.: 11/516,238

(22) Filed: Sep. 6, 2006

(30) Foreign Application Priority Data
Dec. 2, 2005 (KR) 10-2005-0117186

(51) Int. Cl. G09G 5/08

(52) U.S. Cl. 345/157

(57) ABSTRACT

An optical navigation device and a method of operating the same are provided. The optical navigation device includes: an image sensor for obtaining a sampling image; a filter selector for selecting an image filter performing a filtering operation according to an image pattern of the sampling image, and transmitting the sampling image to the selected image filter; an image filter having a plurality of image filters, and filtering the sampling image through the image filter selected from the plurality of image filters to generate an filtering image; and a movement value calculator for calculating a movement value in response to the filtering image. Therefore, it is possible to change the image filter used according to an image pattern or a movement direction of a subject to thereby calculate an accurate movement value corresponding to the image pattern and the movement direction.

### BACKGROUND OF THE INVENTION

1. Field of the Invention

The present invention relates to an optical navigation device, and more particularly, to an optical navigation device and a method of operating the same capable of precisely detecting movement in all directions to more precisely calculate a movement value in all directions.

2. Description of the Related Art

An optical navigation device is a device for irradiating a subject (or a work surface) with light to continuously obtain an image of the subject, and comparing the currently obtained image with the previously obtained image to calculate a movement value.

When such an optical navigation device is implemented as an optical mouse, a data processing speed is a very important factor for determining performance of the device. For this purpose, a general optical navigation device includes a separate image filtering unit for reducing the capacity of the obtained image to reduce data processing capacity, thereby increasing the data processing speed.

However, since a conventional optical navigation device includes only one kind of image filter, it is difficult to actively respond to various movement directions of the optical navigation device.

FIG. 1 is a block diagram of a conventional optical navigation device.

Referring to FIG. 1, the optical navigation device includes an image sensor 1 for accumulating the amount of light reflected from a subject and obtaining an image of the subject as a sampling image having n bits of image quality, an image filter 2 for filtering the sampling image to generate a filtering image having an image quality lower than that of the sampling image, and a movement value calculator 3 for calculating a correlation between the current filtering image and the previous filtering image to calculate a movement value of the optical navigation device.

Therefore, when the optical navigation device in FIG. 1 moves, the image sensor 1 continuously obtains a sampling image having n bits of image quality, and the image filter 2 filters the sampling image in real time to generate a filtering image (or a filtering image having an image quality smaller than n bits) having 1 bit (or the number of bits smaller than n) of image quality.

Then, the movement value calculator 3 calculates a correlation between the previous filtering image and the current filtering image, and obtains a current filtering image having the highest correlation with respect to the previous filtering image to calculate a movement value V (x, y) of the optical navigation device.

As described above, the conventional optical navigation device reduces the number of bits for representing image quality of the sampling image, i.e., each pixel of the sampling image using the image filter, and calculates a movement value, thereby remarkably decreasing data processing capacity.

While the conventional optical navigation device can detect very well movement of a subject having a certain image pattern according to filtering characteristics of the image filter, it may be difficult to detect movement of a subject having another certain image pattern. In addition, due to the same reason, it may be difficult to detect movement in a certain direction.

Therefore, when the conventional optical navigation device uses only one image filter, a movement value according to an image pattern and a movement direction of the subject may not be precisely calculated, thereby reducing the reliability of the optical navigation device.

### SUMMARY OF THE INVENTION

In order to solve the foregoing and/or other problems, it is an aspect of the present invention to provide an optical navigation device including a plurality of image filters and a method of operating the same capable of actively changing the image filters depending on an image pattern or a movement direction of a subject to precisely calculate a movement value in all operation environments.

Additional aspect and advantages of the present invention will be set forth in part in the description which follows and, in part, will be obvious from the description, or may be learned by practice of the invention.

The foregoing and/or other aspects of the present invention may be achieved by providing an optical navigation device including: an image sensor for obtaining a sampling image; a filter selector for selecting an image filter performing a filtering operation according to an image pattern of the sampling image, and transmitting the sampling image to the selected image filter; an image filter having a plurality of image filters, and filtering the sampling image through the image filter selected from the plurality of image filters to generate an filtering image; and a movement value calculator for calculating a movement value in response to the filtering image.

In addition, the filter selector may include an image pattern analyzer for analyzing the sampling image to obtain an image pattern, and selecting an image filter performing a filtering operation according to the obtained image pattern; and a switch for transmitting the sampling image to the selected image filter, and may further include a movement direction analyzer for analyzing the previously calculated movement value to obtain a movement direction, and selecting an image filter performing a filtering operation according to the obtained movement direction.

Another aspect of the present invention may be achieved by providing an optical navigation device including: an image sensor for obtaining a sampling image; an image filter having a plurality of image filters, and filtering the sampling image through the plurality of image filters to generate a plurality of filtering images; a filter selector for selecting one filtering image from the plurality of filtering images according to an image pattern of the sampling image; and a movement value calculator for calculating a movement value in response to the selected filtering image.

In addition, the filter selector may include an image pattern analyzer for analyzing the sampling image to obtain an image pattern, and selecting one image filter from the plurality of image filters according to the obtained image pattern; and a switch for transmitting the filtering image only of the selected image filter to the movement value calculator, and may further include a movement direction analyzer for analyzing the previously calculated movement value to obtain a movement direction, and selecting one image filter from the plurality of image filters according to the obtained movement direction.

Still another aspect of the present invention may be achieved by providing a method of operating an optical navigation device including: obtaining a sampling image; selecting one image filter from a plurality of image filters according to an image pattern of the sampling image; generating a filtering image by filtering the sampling image through the selected image filter; and calculating a movement value in response to the filtering image.

Yet another aspect of the present invention may be achieved by providing a method of operating an optical navigation device including: obtaining a sampling image; filtering the sampling image through a plurality of image filters to generate a plurality of filtering images; selecting one filtering image from the plurality of filtering images according to an image pattern of the sampling image; and calculating a movement value in response to the selected filtering image.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a block diagram of a conventional optical navigation device;

FIG. 2 is a diagram illustrating movement directions of an optical mouse;

FIGS. 3A to 3C are diagrams for explaining image filters appropriate to each image pattern of a subject;

FIG. 4 is a block diagram of an optical navigation device in accordance with a first embodiment of the present invention;

FIG. 5 is a flowchart illustrating a method of operating the optical navigation device in FIG. 4;

FIG. 6 is a block diagram of an optical navigation device in accordance with a second embodiment of the present invention;

FIG. 7 is a diagram for explaining a logical correlation between a movement direction corresponding to a movement value and an image filter;

FIG. 8 is a flowchart illustrating a method of operating the optical navigation device in FIG. 7;

FIG. 9 is a block diagram of an optical navigation device in accordance with a third embodiment of the present invention;

FIG. 10 is a flowchart illustrating a method of operating the optical navigation device in FIG. 8;

FIG. 11 is a block diagram of an optical navigation device in accordance with a fourth embodiment of the present invention; and

FIG. 12 is a flowchart illustrating a method of operating the optical navigation device in FIG. 11.

### DETAILED DESCRIPTION OF THE INVENTION

Reference will now be made in detail to the embodiments of the present invention, examples of which are illustrated in the accompanying drawings. The embodiments are described below in order to explain the present invention by referring to the figures.

Before describing an optical navigation device in accordance with an embodiment of the present invention, image filters appropriate to image patterns of a subject will be first described.

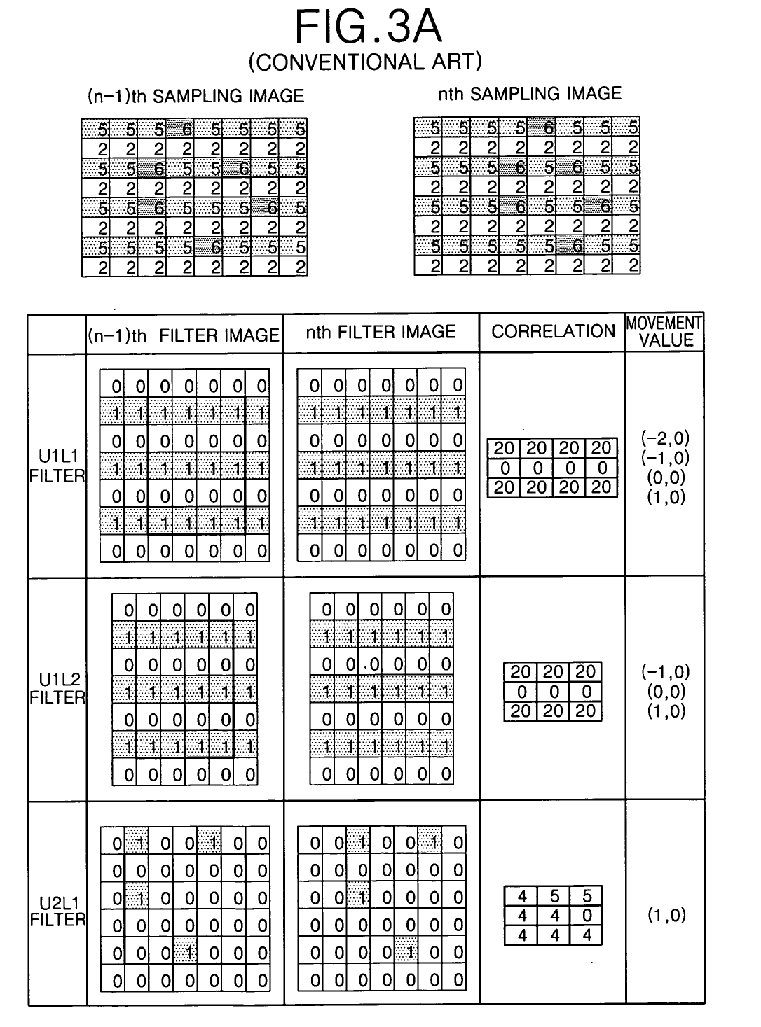

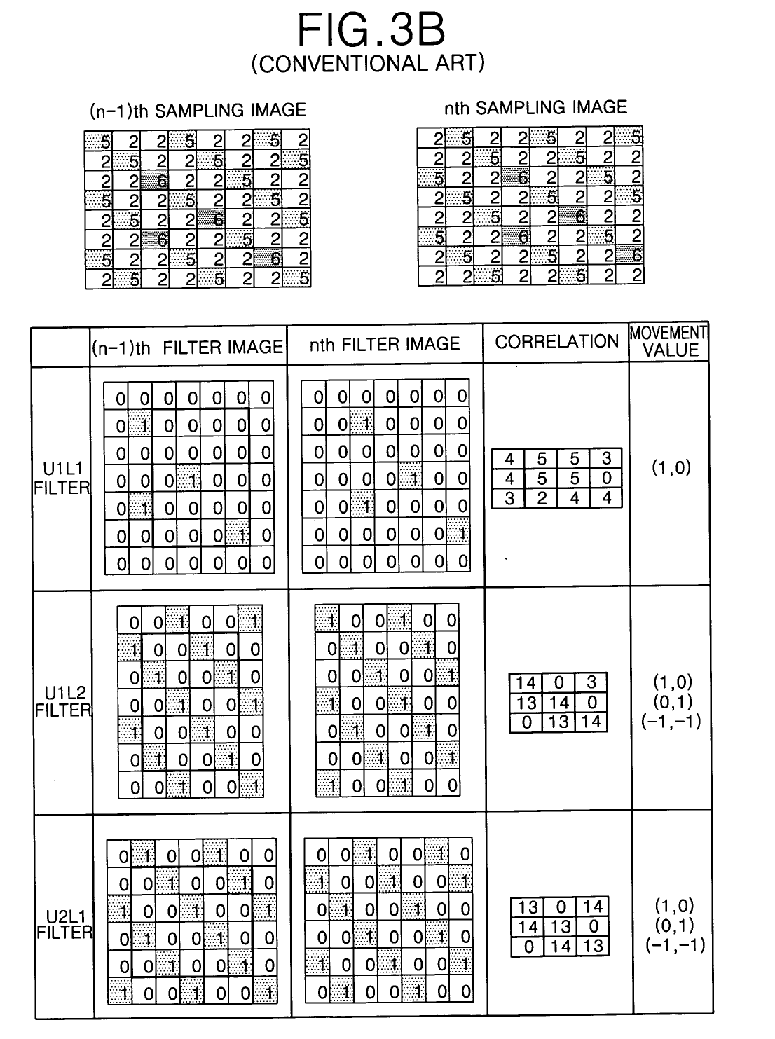

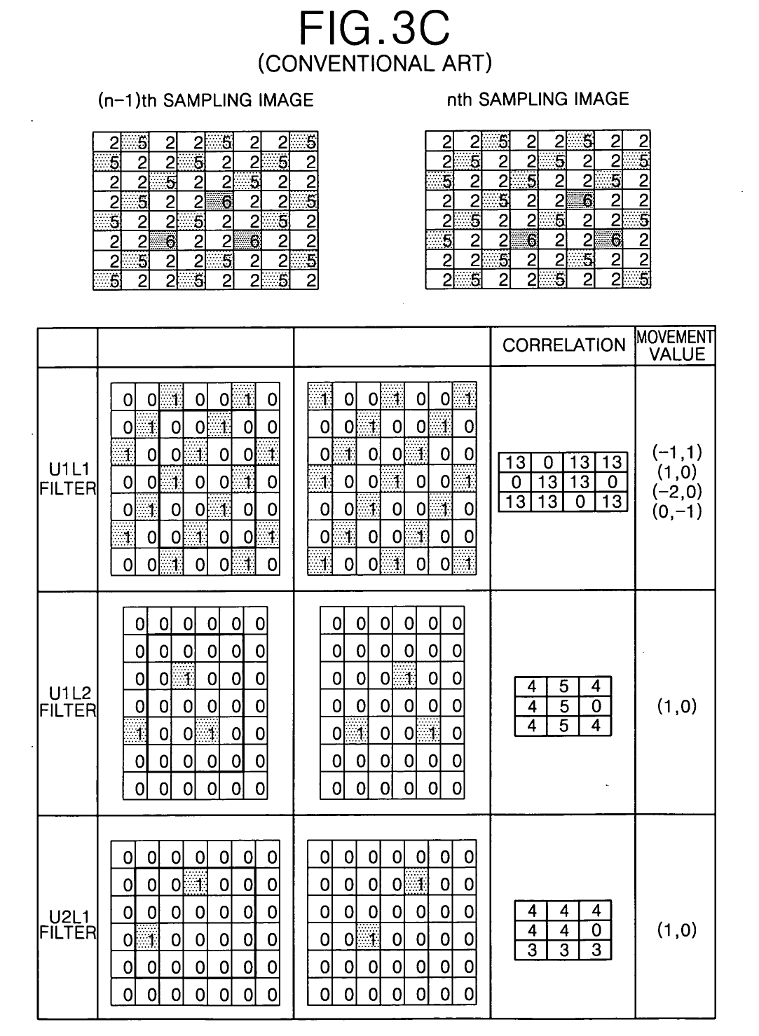

FIGS. 3A to 3C are diagrams for explaining image filters appropriate to each image pattern of a subject.

At this time, a U1L1 (Upper-1 Left-1) filter is a filter obtaining a filtering value of a reference pixel by comparing the reference pixel with a pixel having a distance value of (1, −1) with respect to the reference pixel, a U1L2 (Upper-1 Left-2) filter is a filter obtaining a filtering value of a reference pixel by comparing the reference pixel with a pixel having a distance value of (1, —2) with respect to the reference pixel, and a U2L1 (Upper-2 Left-1) filter is a filter obtaining a filtering value of a reference pixel by comparing the reference pixel with a pixel having a distance value of (2, −1) with respect to the reference pixel.

Referring first to FIG. 3A, an image filter appropriate to a sampling image having horizontally repeated patterns will be described.

When sampling images having horizontally repeated patterns and moving by one pixel (1, 0) rightward during (n−1)th and nth sampling operations are input, each of the U1L1 filter, U1L2 filter, and U2L1 filter generates (n−1)th and nth filtering images having different pixel values.

When calculating a movement value of the optical navigation device using filtering images generated through the U1L1 filter, since the nth filtering image has the highest correlation value among all positions that a reference area RA of the (n−1)th filtering image is moved by (−2,0),(−1,0),(0,0) and (1,0), the optical navigation device obtains a plurality of movement values (−2,0),(−1,0),(0,0) and (1,0).

In this process, the correlation means a similarity between the reference area obtained through the (n−1)th filtering image and an arbitrary area in the nth filtering image. In the present invention, the correlation is obtained by moving the reference area obtained through the (n−1)th filtering image on the nth filtering image in a zigzag to obtain an absolute difference value between each pixel of the areas. As the absolute difference value between the pixels is low, the correlation becomes high. At this time, the reference area RA is an area represented as a thick solid line in the (n−1)th filtering image.

Using a filtering image generated through the U1L2 filter, since an nth filtering image has the highest correlation values at all position that a reference area RA of an (n−1)th filtering image is moved by (−1,0), (0,0) and (1,0), the optical navigation device obtains also a plurality of movement values (−1,0), (0,0) and (1,0).

On the other hand, using a filtering image generated through the U2L1 filter, since an nth filtering image has the highest correlation value at a position only that a reference area RA of an (n−1)th filtering image is moved by (1,0), the optical navigation device obtains one movement value (1,0).

Generally, when the optical navigation device calculates a movement value, since obtaining only one movement value is the most ideal, it will be appreciated that an image filter appropriate to the sampling image having horizontally repeated patterns is the U2L1 filter.

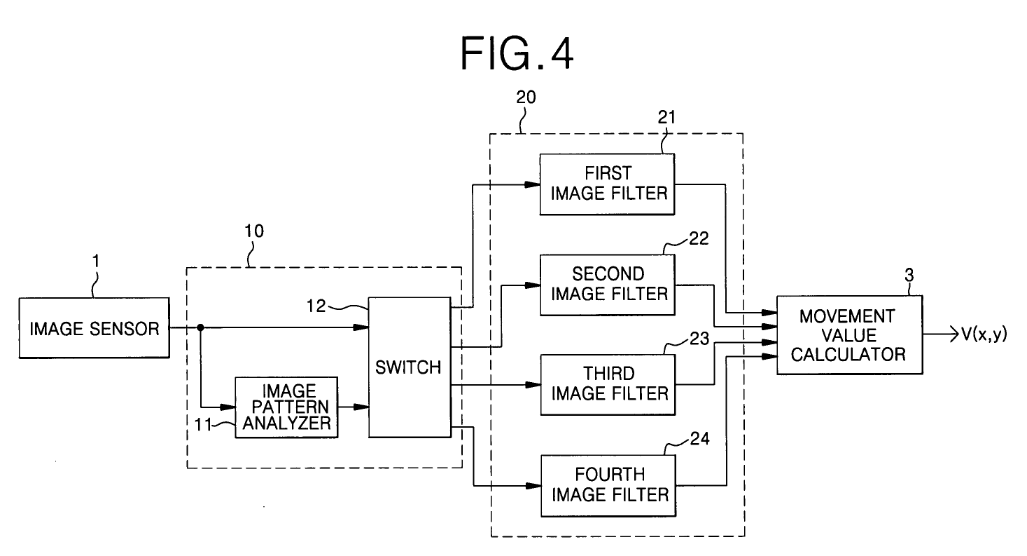

Similarly, it will be appreciated that an image filter appropriate to a sampling image having diagonally repeated patterns with a slope of −1 in FIG. 3B is a U1L1 filter, and an image filter appropriate to a sampling image having diagonally repeated patterns with a slope of 1 in FIG. 3C is a U1L2 or U2L1 filter FIG. 4 is a block diagram of an optical navigation device in accordance with a first embodiment of the present invention.

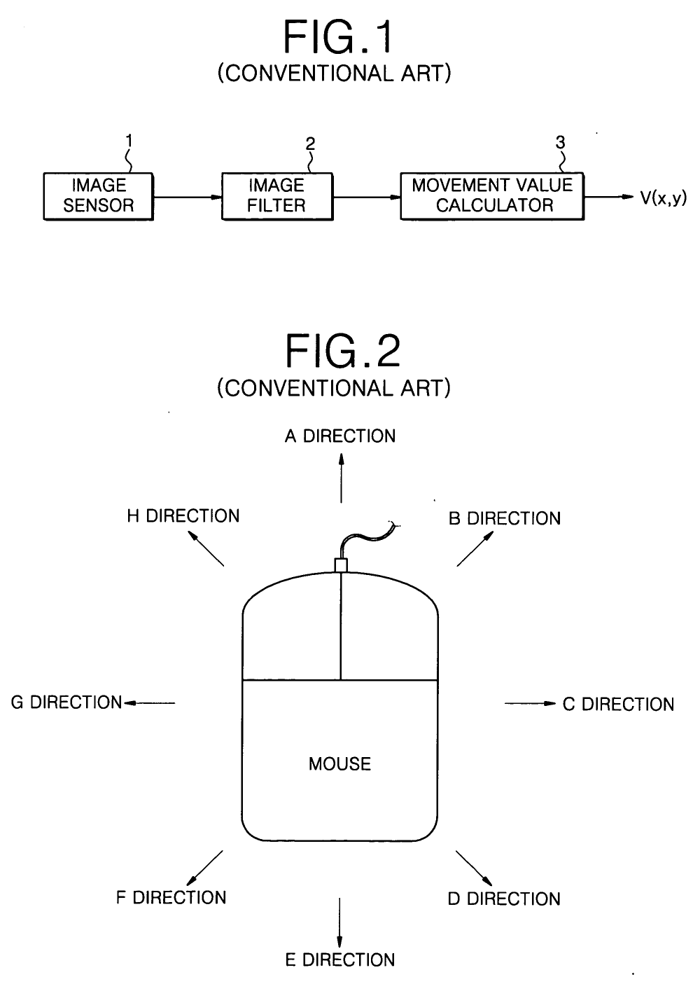

Referring to FIG. 4, the optical navigation device includes an image sensor 1 and a movement value calculator 3 similarly to the embodiment of FIG. 1, and further includes a filter selector 10 having an image pattern analyzer 11 and a switch 12. In the optical navigation device, the image filter 2 of FIG. 1 is replaced with an image filter 20 having a plurality of image filters 21 to 24.

The image sensor 1 includes a plurality of pixels, each of which accumulates the amount of light reflected from a subject to generate n bits of data. Therefore, the image sensor 1 generates a sampling image having n bits of image quality.

The image pattern analyzer 11 analyzes the received sampling image and determines an image pattern of a subject image, and selects an image filter corresponding to an image pattern similar or equal to the determined image pattern as a usable image filter.

For example, in a case that the image filter 20 includes a U1L1 filter, a U1L2 filter, a U2L1 filter, and so on, the image pattern analyzer 11 selects the U2L1 filter as a usable image filter when a sampling image having the image pattern shown in FIG. 3A is received, selects the U1L1 filter as a usable image filter when a sampling image having the image pattern shown in FIG. 3B is received, and selects the U1L2 filter as a usable image filter when a sampling image having the image pattern shown in FIG. 3C is received.

The switch 12 receives the sampling image from the image sensor 1, and transmits the sampling image received under the control of the image pattern analyzer 11 to the image filter selected as the usable image filter.

The image filter 20 includes a plurality of image filters 21 to 24 corresponding to different image patterns, each of which filters a sampling image having n bits of image quality through one image filter 21 receiving the sampling image to generate a filtering image (or a filtering image having n bits or less of image quality) having one bit (or the limited number of bits less than n) of image quality. That is, the image filter 20 generates a filtering image representing an image of each pixel as one bit (or the limited number of bits less than n).

The movement value calculator 3 calculates a correlation between the currently generated filtering image and the previously generated filtering image to obtain a movement value V (x, y) of the optical navigation device at a position of a sampling image having the highest correlation value, and outputs the obtained movement value V (x, y) to the exterior.

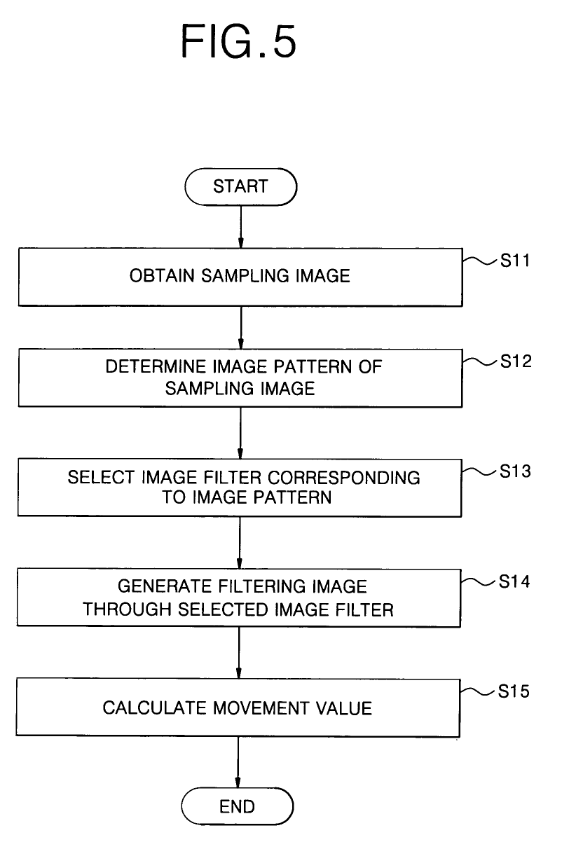

A method of operating an optical navigation device will now be described with reference to FIG. 5.

An image sensor 1 obtains an image of a subject as a sampling image having n bits of image quality, and transmits the sampling image to an image pattern analyzer 11 and a switch 12 (S11).

The image pattern analyzer 11 analyzes the sampling image to determine an image pattern of the subject (S12), obtains an image filter corresponding to the determined image pattern, and selects the obtained image filter as a usable image filter (S13).

The switch 12 transmits the received sampling image to the image filter selected as the usable image filter in step S13, and the image filter, in which the sampling image is received, performs a filtering operation to generate a filtering image having one bit of image quality (S14).

A movement value calculator 3 calculates a correlation between the filtering image newly generated in step S14 and the previously generated filtering image to obtain a movement value V (x, y) of the optical navigation device, and then outputs the movement value to the exterior (S15).

Therefore, the optical navigation device of FIG. 4 may select the sampling image, i.e., an image filter to be used depending on an image pattern of the subject image, so that movement of the optical navigation device can be detected regardless of the image pattern of the subject image.

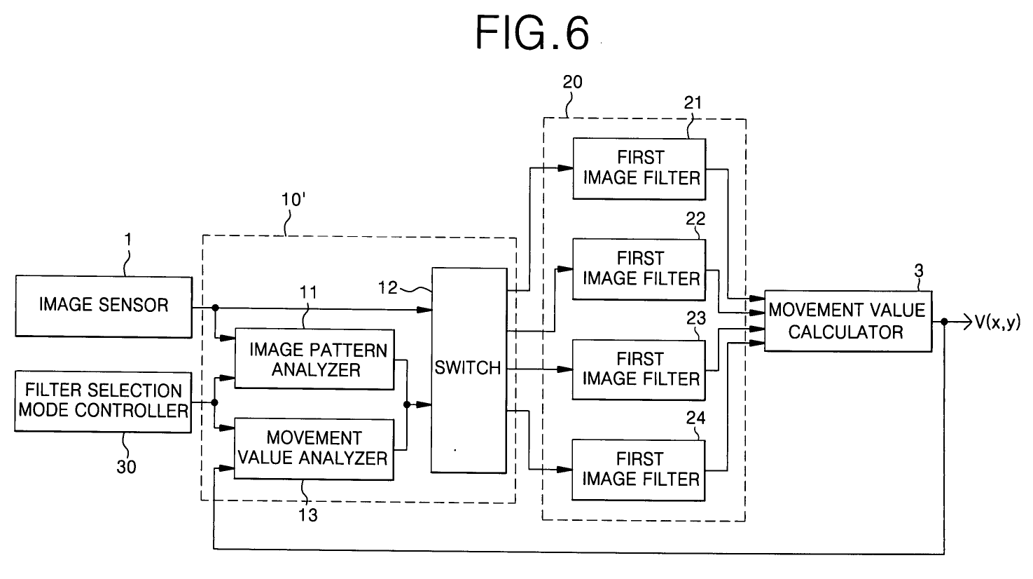

In addition, if necessary, the optical navigation device may selects an image filter to be used depending on a movement direction as shown in FIG. 6 to detect movement of the optical navigation device in all directions.

FIG. 6 is a block diagram of an optical navigation device in accordance with a second embodiment of the present invention.

Referring to FIG. 6, the optical navigation device includes an image sensor 1, an image filter 20, and a movement value calculator 3 similarly to the embodiment of FIG. 4, and further includes a filter selection mode controller 30. In FIG. 6, the filter selector 10 of FIG. 4 is replaced with a filter selector 10′.

In FIG. 6, components that are the same as in FIG. 4 are designated by the same reference numerals and their descriptions will not be repeated below.

The filter selector 10′ further includes a movement value analyzer 13, in addition to the image pattern part 11 and the switch 12 of FIG. 4.

When the previously calculated movement value V (x, y) of the optical navigation device is fed back from the movement value calculator 3 to the movement value analyzer 13, the movement value analyzer 13 analyzes the fed back movement value V (x, y) to determine a movement direction of the optical navigation device, and selects an image filter corresponding to the determined movement direction as a usable image filter.

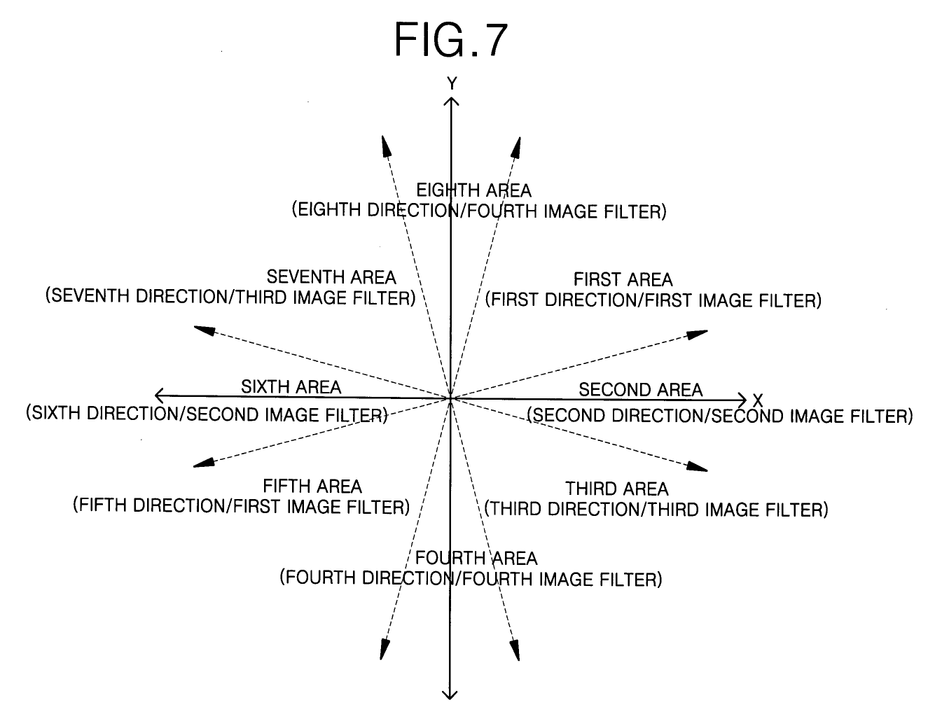

For example, in the case that a movement direction corresponding to the movement value V (x, y) and an image filter corresponding to the movement direction are set according to a logical correlation in FIG. 7, when the movement value V (x, y) included in a first area is fed back, the movement value analyzer 13 obtains a first direction as a movement direction of the optical navigation device, and obtains the first image filter 21 as a usable image filter.

The filter selection mode controller 30 selects a filter selection mode of the optical navigation device in response to a user's request, an input of an external device, or another operation unit. For example, in an optical mouse, the filter selection mode can be selected by a computer. In this case, after the computer monitors the movement value generated by the movement value calculator 3, the computer controls the filter selection mode. Similarly, the filter selection mode can be selected by another operation unit (not shown) on a single chip. Then, when the selected filter selection mode is an image pattern selection mode, the filter selection mode controller 30 operates the image pattern analyzer 11 only to select an image filter to be used according to an image pattern of the sampling image, and when the selected filter selection mode is a movement direction selection mode, the filter selection mode controller 30 operates the movement value analyzer 13 only to select an image filter to be used according to the movement direction of the optical navigation device. It is possible for the filter selection mode controller 30 to switch between an image pattern selection mode and a movement direction selection mode automatically. For example, when the movement values are consistent i.e., there are no abrupt direction changes or abnormal value changes, the filter selection mode is set to the movement direction selection mode. Otherwise, when the movement values are inconsistent, the filter selection mode is set to the image pattern selection mode.

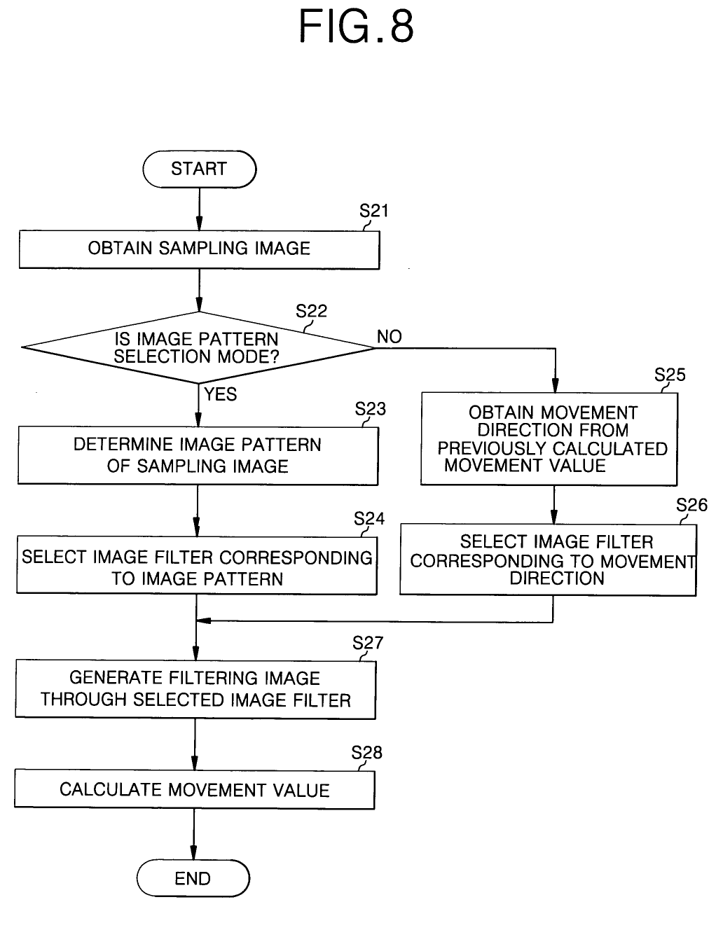

A method of operating an optical navigation device will now be described with reference to FIG. 8.

An image sensor 1 obtains an image of a subject as a sampling image having n bits of image quality, and transmits the sampling image to an image pattern analyzer 11 and a switch 12 (S21).

When a filter selection mode of a filter selection mode controller 30 is an image pattern selection mode (S22), the filter selection mode controller 30 operates the image pattern analyzer 11 only.

Then, the image pattern analyzer 11 analyzes the sampling image to determine an image pattern of the subject (S23), obtains an image filter corresponding to the determined image pattern, and then selects the obtained image filter as a usable image filter (S24).

On the other hand, in step S22, when the filter selection mode of the filter selection mode controller 30 is a movement direction pattern selection mode, the filter selection mode controller 30 operates a movement value analyzer 13 only.

Then, the movement value analyzer 13 analyzes the previously calculated movement value V (x, y) to obtain a movement direction of the optical navigation device (S25), obtains an image filter corresponding to the obtained movement direction, and then selects the obtained image filter as a usable image filter (S26).

The switch 12 transmits the received sampling image to the image filter selected as the usable image filter in step S24 or S26, and the image filter, in which the sampling image is received, operates a filtering operation to generate a filtering image having one bit of image quality (S27).

A movement value calculator 3 calculates a correlation between the filtering image newly generated in step S27 and the previously generated filtering image, and obtains a movement value V (x, y) of the optical navigation device to output the movement value to the exterior (S28).

Therefore, the optical navigation device of FIG. 6 may select an image filter according to an image pattern of the subject, or select an image filter according to a movement direction of the optical navigation device, in response to a user's request or an input of the exterior.

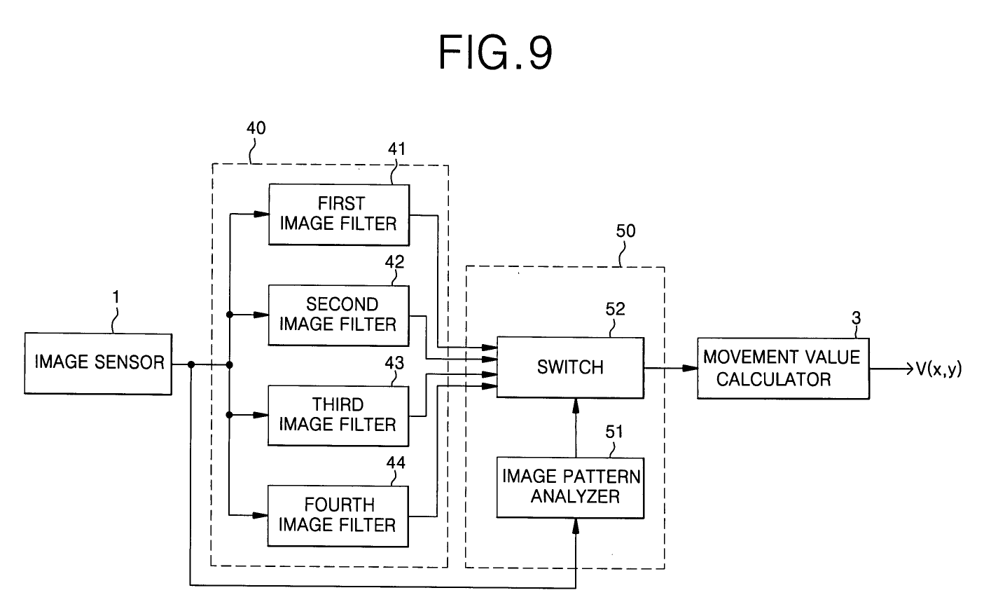

FIG. 9 is a block diagram of an optical navigation device in accordance with a third embodiment of the present invention.

Referring to FIG. 9, the optical navigation device of the present invention includes an image sensor 1, and a movement value calculator 3, similarly to the embodiment of FIG. 4, and the filter selector 10 and the image filter 20 of FIG. 4 are replaced with a filter selector 50 and an image filter 40. The image filter 40 of FIG. 9 includes a plurality of image filters 41 to 44, and the filter selector 50 includes an image pattern analyzer 51 and a switch 52.

In FIG. 9, components that are the same as in FIG. 4 are designated by the same reference numerals and their descriptions will not be repeated below.

The image filter 40 includes the plurality of image filters 41 to 44 corresponding to different image patterns, each of which simultaneously receive and filter sampling images having n bits of image quality to generate a plurality of filtering images having one bit (or the limited number of bits less than n) of image quality.

The image pattern analyzer 51 analyzes the received sampling image, similarly to the image pattern analyzer 11 of FIG. 4, determines an image pattern of a subject, and selects an image filter corresponding to an image pattern similar or equal to the determined image pattern as a usable image filter. The image pattern analyzer 51 can be implemented to analyze the filtering images (not shown). In this case, the image pattern analyzer 51 can be implemented with a simple construction, since each of the filtering images is one-bit data, as shown in FIGS. 3A, 3B, and 3C. Conversely, as shown in FIG. 9, if the image pattern analyzer 51 is implemented to analyze the received sampled image in n-bit data, its structure becomes more complicated.

The switch 52 receives a plurality of filtering images, and selects a filtering image generated by the usable image filter 41 of the plurality of filtering images under the control of the image pattern analyzer 51 to transmit the filtering image to the movement value calculator 3.

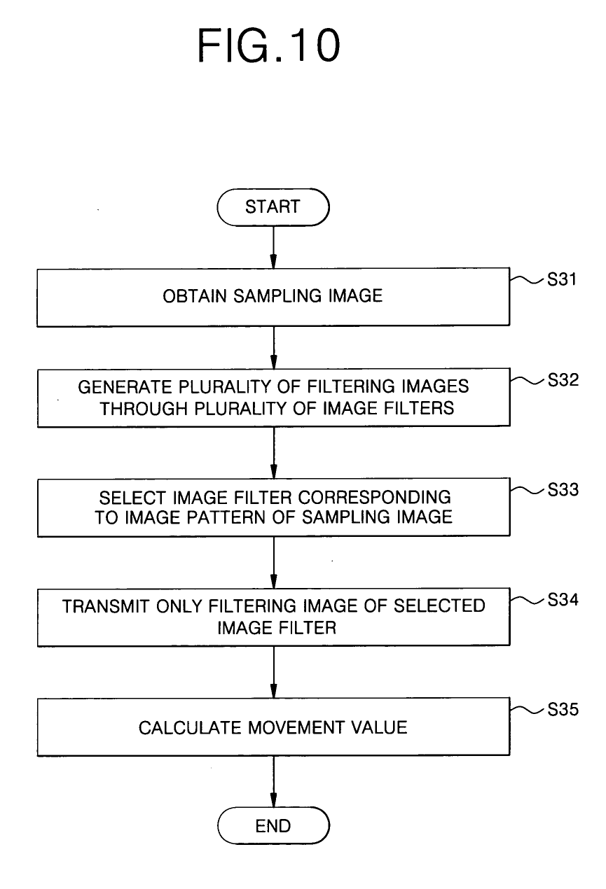

A method of operating an optical navigation device will now be described with reference to FIG. 10.

An image sensor 1 obtains an image of a subject as a sampling image having n bits of image quality, and simultaneously transmits the sampling image to a plurality of image filters 41 to 44 and an image pattern analyzer 51 (S31).

Then, the plurality of image filters 41 to 44 perform filtering operations to generate a plurality of filtering images having one bit of image quality (S32), and the image pattern analyzer 51 analyzes the sampling image to determine an image pattern of the subject, obtains an image filter appropriate to the determined image pattern, and then, selects the obtained image filter as a usable image filter (S33).

Next, a switch 52 receives a plurality of filtering images from the plurality of image filters 41 to 44, and transmits only an image of the image filter selected in step S33 to a movement value calculator 3 (S34).

The movement value calculator 3, in which the filtering image of the usable image filter is received, calculates a correlation between the newly input filtering image and the previously input filtering image to obtain a movement value V (x, y) of the optical navigation device, and outputs the movement value to an external device (S35).

Therefore, the optical navigation device of FIG. 9 may also select the sampling image, i.e., the image filter to be used depending on an image pattern of the subject image to detect movement of the optical navigation device regardless of the image pattern of the subject image.

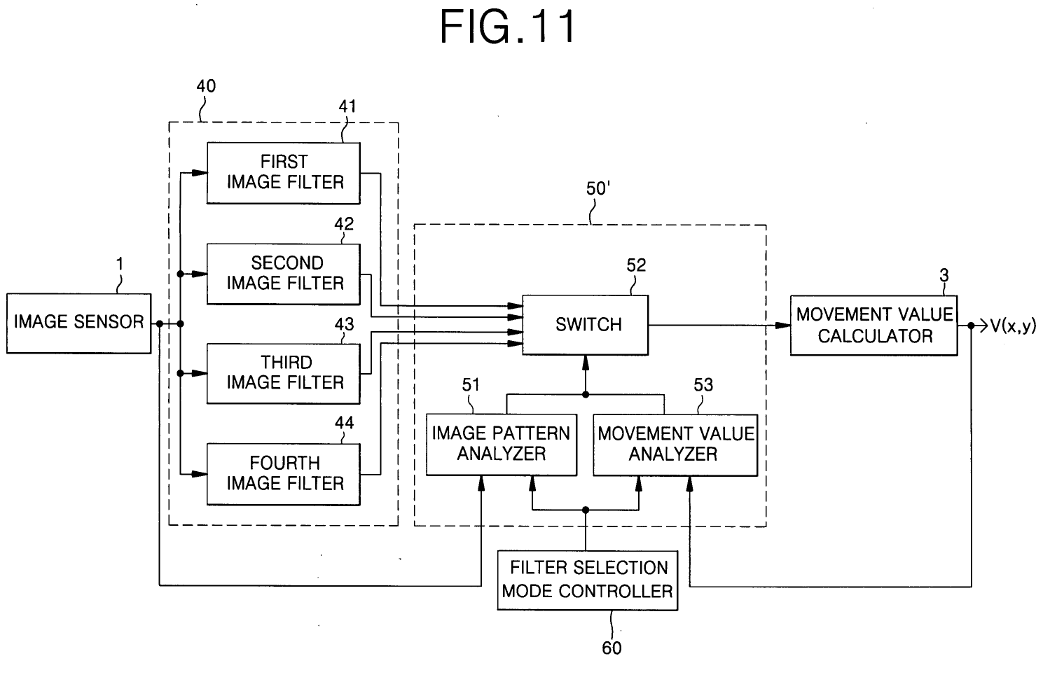

In addition, if necessary, the optical navigation device of FIG. 9 may select an image filter to be used depending on a movement direction as shown in FIG. 11 to detect movement of the optical navigation device in all directions.

FIG. 11 is a block diagram of an optical navigation device in accordance with a fourth embodiment of the present invention.

Referring to FIG. 11, the optical navigation device includes an image sensor 1, an image filter 40, and a movement value calculator 3 similarly to the embodiment of FIG. 9, and further includes a filter selection mode controller 60. In FIG. 11, the filter selector 50 of FIG. 9 is replaced with a filter selector 50′.

In FIG. 11, components that are the same as in FIG. 9 are designated by the same reference numerals and their descriptions will not be repeated below.

The filter selector 50′ further includes a movement value analyzer 53, in addition to the image pattern analyzer 51 and the switch 52 of FIG. 9.

The movement value analyzer 53 receives the previously calculated movement value V (x, y) of the optical navigation device fed back from the movement value calculator 3, similarly to the movement value analyzer 13 of FIG. 6, analysis the fed back movement value V (x, y) to determine a movement direction of the optical navigation device, and selects an image filter corresponding to the determined movement direction as a usable image filter.

The filter selection mode controller 60 selects a filter selection mode of the optical navigation device in response to a user's request, an input of an external device, or another operation unit (not shown) similarly to the filter selection mode controller 30 of FIG. 6. When the selected filter selection mode is an image pattern selection mode, the filter selection mode controller 60 operates only the image pattern analyzer 51 to select an image filter to be used according to an image pattern of a sampling image, and when a movement direction selection mode, the filter selection mode controller 60 operates only the movement value analyzer 53 to select an image filter to be used according to a movement direction of the optical navigation device.

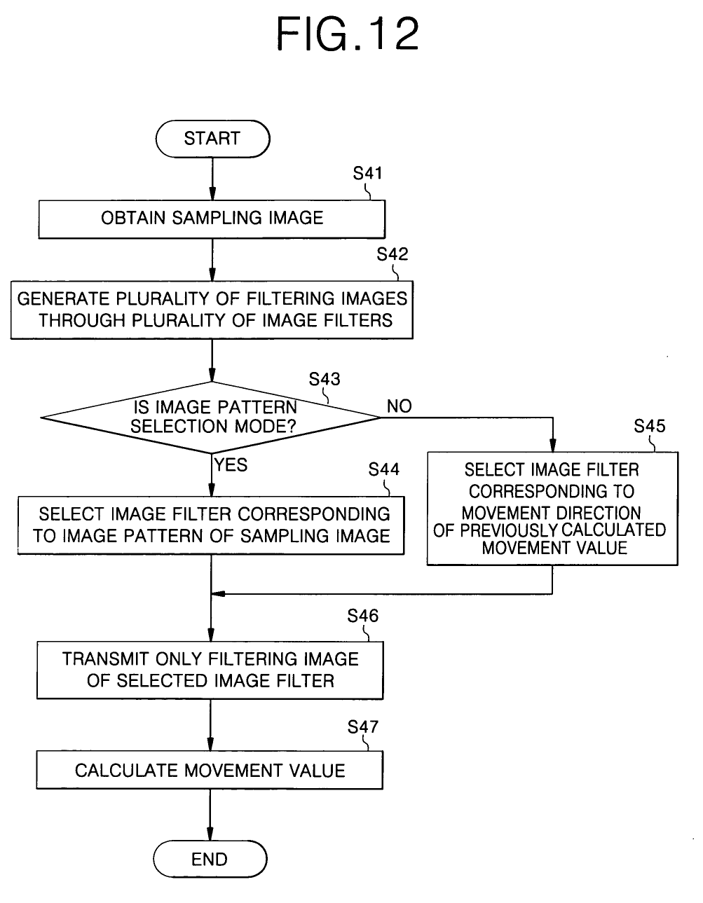

A method of operating an optical navigation device will now be described with reference to FIG. 12.

An image sensor 1 obtains an image of a subject as a sampling image having n bits of image quality, and simultaneously transmits the sampling image to a plurality of image filters 41 to 44 and an image pattern analyzer 51 (S41).

Then, the plurality of image filters 41 to 44 perform filtering operations to generate a plurality of filtering images having one bit of image quality (S42). When a filter selection mode of a filter selection mode controller 60 is an image pattern selection mode (S43), the filter selection mode controller 60 operates the image pattern analyzer 51 only.

The image pattern analyzer 51 enabled in step S43 analyzes the sampling image to determine an image pattern of a subject, obtains an image filter appropriate to the determined image pattern, and then selects the obtained image filter as a usable image filter (S44).

On the other hand, in step 43, when a filter selection mode of the filter selection mode controller 60 is a movement direction selection mode, the filter selection mode controller 60 operates a movement value analyzer 53 only.

Then, the movement value analyzer 53 analyzes the previously calculated movement value V (x, y) to obtain a movement direction of the optical navigation device, obtains an image filter corresponding to the obtained movement direction, and then selects the obtained image filter as a usable image filter (S45).

Next, a switch 52 receives a plurality of filtering images from the plurality of image filters 41 to 44, and transmits only the filtering image of the usable image filter selected in step S44 or S45 to a movement value calculator 3 (S46).

The movement value calculator 3 calculates a correlation between the newly input filtering image and the previously input filtering image to obtain a movement value V (x, y) of the optical navigation device, and outputs the movement value to an external device (S47).

Therefore, the optical navigation device of FIG. 11 may also select an image filter according to an image pattern of the subject, or select an image filter according to a movement direction of the optical navigation device, in response to a user's request or an input of the exterior.

While the above embodiments describe the filter selector including the image pattern analyzer only, or including both the image pattern analyzer and the movement value analyzer, if necessary, the filter selector may include the movement value analyzer only.

In addition, while the above embodiments describe the number of bits representing the pixel of the filtering image as one bit, the number of bits may be variously adjusted within a range equal to or smaller than the number of bits representing the sampling image, depending on operating characteristics of the optical navigation device.

As can be seen from the foregoing, an optical navigation device in accordance with the present invention includes a plurality of image filters, and actively changes the image filter used according to an image pattern or a movement direction of a subject to calculate accurate movement values corresponding to all the image patterns and movement directions. Therefore, it is possible to enhance reliability of the optical navigation device.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An optical navigation device comprising:
an image sensor for obtaining a sampling image;
a filter selector for selecting an image filter performing a filtering operation according to an image pattern of the sampling image, and transmitting the sampling image to the selected image filter;
an image filter having a plurality of image filters, and filtering the sampling image through the image filter selected from the plurality of image filters to generate an filtering image; and
a movement value calculator for calculating a movement value in response to the filtering image.

2. The optical navigation device according to claim 1, wherein the filter selector comprises:
an image pattern analyzer for analyzing the sampling image to obtain an image pattern, and selecting an image filter to be used according to the obtained image pattern; and
a switch for transmitting the sampling image to the selected image filter.

3. The optical navigation device according to claim 2, wherein the filter selector further comprises a movement direction analyzer for analyzing the previously calculated movement value to obtain a movement direction, and selecting an image filter to be used according to the obtained movement direction.

4. The optical navigation device according to claim 3, further comprising a filter selection mode controller for selecting a filter selection mode, operating the image pattern analyzer when the filter selection mode is an image pattern selection mode, and operating the movement direction analyzer when the filter selection mode is a movement direction selection mode.

5. The optical navigation device according to claim 1, wherein the number of bits representing a pixel of the filtering image is equal to or smaller than the number of bits representing a pixel of the sampling image.

6. An optical navigation device comprising:
an image sensor for obtaining a sampling image;
an image filter having a plurality of image filters, and filtering the sampling image through the plurality of image filters to generate a plurality of filtering images;
a filter selector for selecting one filtering image from the plurality of filtering images according to an image pattern of the sampling image or image patterns of the plurality of image filters; and
a movement value calculator for calculating a movement value in response to the selected filtering image.

7. The optical navigation device according to claim 6, wherein the filter selector comprises:
an image pattern analyzer for analyzing the sampling image to obtain an image pattern, and selecting one image filter from the plurality of image filters according to the obtained image pattern; and
a switch for transmitting only the filtering image of the selected image filter to the movement value calculator.

8. The optical navigation device according to claim 7, the filter selector further comprises a movement direction analyzer for analyzing the previously calculated movement value to obtain a movement direction, and selecting one image filter from the plurality of image filters according to the obtained movement direction.

9. The optical navigation device according to claim 8, further comprising a filter selection mode controller for selecting a filter selection mode, operating the image pattern analyzer when the filter selection mode is an image pattern selection mode, and operating the movement direction analyzer when the filter selection mode is a movement direction selection mode.

10. The optical navigation device according to claim 6, wherein the number of bits representing a pixel of the filtering image is equal to or smaller than the number of bits representing a pixel of the sampling image.

11. A method of operating an optical navigation device, comprising:
obtaining a sampling image;
selecting one image filter from a plurality of image filters according to an image pattern of the sampling image;
generating a filtering image by filtering the sampling image through the selected image filter; and
calculating a movement value in response to the filtering image.

12. The method according to claim 11, wherein selecting the image filter comprises:
selecting a filter selection mode; and
selecting an image filter to be used according to an image pattern of the sampling image when the filter selection mode is an image pattern selection mode.

13. The method according to claim 12, wherein selecting the image filter further comprises analyzing the previously calculated movement value to obtain a movement direction when the filter selection mode is a movement direction selection mode, and selecting an image filter to be used according to the obtained movement direction.

14. The method according to claim 11, wherein the number of bits representing a pixel of the filtering image is equal to or smaller than the number of bits representing a pixel of the sampling image.

15. A method of operating an optical navigation device, comprising:
obtaining a sampling image;
filtering the sampling image through a plurality of image filters to generate a plurality of filtering images;
selecting one filtering image from the plurality of filtering images according to an image pattern of the sampling image or image patterns of the plurality of image filters; and
calculating a movement value in response to the selected filtering image.

16. The method according to claim 15, wherein selecting the image filter comprises:
selecting a filter selection mode; and
selecting one filtering image from the plurality of filtering images according to an image pattern of the sampling image when the filter selection mode is an image pattern selection mode.

17. The method according to claim 16, wherein selecting the image filter further comprises analyzing the previously calculated movement value to obtain a movement direction when the filter selection mode is a movement direction selection mode, and selecting one filtering image from the plurality of filtering images according to the obtained movement direction.

18. The method according to claim 15, wherein the number of bits representing a pixel of the filtering image is equal to or smaller than the number of bits representing a pixel of the sampling image.
